(19) United States
(12) Patent Application Publication
(10) Pub. No.: US 2021/0303852 A1
(43) Pub. Date: Sep. 30, 2021

(54) SYSTEM AND METHOD OF AUTOMATICALLY SELECTING ONE OR MORE STORAGE LOCKERS BASED ON DYNAMICALLY ACQUIRED DELIVERED ITEM VOLUME AND LOCKER VOLUME COMPATIBILITY AND AVAILABILITY

(71) Applicant: Position Imaging, Inc., Portsmouth, NH (US)

(72) Inventors: Edward L. Hill, Conway, NH (US); Narasimhachary Nallana Chakravarty, Rollinsford, NH (US)

(21) Appl. No.: 17/193,080

(22) Filed: Mar. 5, 2021

Related U.S. Application Data
(60) Provisional application No. 63/000,555, filed on Mar. 27, 2020.

(51) Int. Cl. G06K 9/00; H04R 1/02; G06F 3/16; G06F 3/0481; G06T 7/20; G06K 9/46; G06T 7/70; G06T 7/62; G06K 9/22; G06F 3/0484; G07C 9/00

(52) U.S. Cl. CPC G06K 9/00664; H04R 1/025; G06F 3/165; G06F 3/0481; G06T 7/20; G06K 9/46; G08B 5/36; G06T 7/62; G06K 9/22; G06F 3/04842; G07C 9/00912; G06T 2207/30204; G06T 7/70

(57) ABSTRACT

A system comprises a memory maintaining storage volume data and availability of each locker of a plurality of lockers; one or more cameras; and a device in communication with the one or more cameras, the device having a processing unit communicating with the one or more cameras that perform an imaging scan of the object to be placed into one of the plurality of lockers, to collect image data of one or more objects detected in the imaging scan, and to measure a volume of the one or more objects based on the collected image data; and a processor configured to select, based on the measured volume of the one or more objects and on the storage volume and availability of each locker, one or more lockers of the plurality of lockers with enough storage volume to enclose the one or more objects.

### RELATED APPLICATIONS

This application claims priority to U.S. provisional application No. 63/000,555, filed Mar. 27, 2020 and entitled “System and Method of Automatically Selecting One or More Storage Lockers Based on Dynamically Acquired Delivered Item(s) Volume and Locker Volume Compatibility and Availability,” the entirety of which is incorporated by reference herein.

### FIELD OF THE INVENTION

The invention relates generally to storage locker management. More particularly, the invention relates to systems and methods for managing lockers for storing objects.

### SUMMARY

In one aspect, the inventive concepts feature a system comprising: memory maintaining storage volume data and availability of each locker of a plurality of lockers; one or more cameras; and a device in communication with the one or more cameras, the device having a processing unit communicating with the one or more cameras that perform an imaging scan of the object to be placed into one of the plurality of lockers, to collect image data of one or more objects detected in the imaging scan, and to measure a volume of the one or more objects based on the collected image data; and a processor configured to select, based on the measured volume of the one or more objects and on the storage volume and availability of each locker, one or more lockers of the plurality of lockers with enough storage volume to enclose the one or more objects.

Embodiments of the system may include one or more of the following features, or any combination thereof.

The one or more cameras are included in a handheld mobile device. The one or more cameras is/are fixed at a location where the one or more cameras has/have a field of view that covers the entire object.

The processing unit of the device comprises the processor that is configured to select one or more lockers of the plurality of lockers with enough storage volume to enclose the one or more objects. The system further comprises a locker station in communication with the device, the locker station sending the storage volume data and availability of each locker of the plurality of lockers to the device, the device sending to the locker station an identity of each selected locker, and the locker station opening a door of each locker selected by the device.

The system further comprises a locker station in communication with the device, the device sending to the locker station the measured volume of the one or more objects detected in the camera's or cameras' imaging scan, and the locker station comprising the processor configured to select one or more lockers of the plurality of lockers that has enough storage volume to enclose the one or more objects. The processor of the locker station causes a door of each selected locker to open automatically.

The processing unit detects multiple objects in the imaging scan and is further configured to recommend an arrangement in which to place the multiple objects within the one or more selected lockers. The processing unit is further configured to consider fragility and/or weight of each object of the multiple objects when recommending an arrangement in which to place the multiple objects within the one or more selected lockers.

The processing unit detects multiple objects in the imaging scan and is further configured to select multiple lockers to place the multiple objects in and to recommend which subset of the multiple objects to place in each selected locker.

The system further comprises a light source, and wherein the processing unit is further configured to use light to guide personnel to the one or more selected lockers, with a light source illuminating the selected lockers either from a remote source such as a laser or light projector or on or near the locker(s) itself such as an LED light above, on or inside each locker.

The system further comprises a speaker, and wherein the processing unit is further configured to use audio cues to guide personnel to the one or more selected lockers.

The processing unit is configured to display a graphical user interface with a button and to trigger the imaging scan when the button is pressed.

The processing unit is configured to detect motion in captured images corresponding to the placement of the one or more objects in or on an area near the lockers and to trigger the imaging scan when the motion has ceased.

The processing unit is configured to recognize a feature or object near the lockers and to trigger the imaging scan in response to this recognized feature or object.

The processing unit is configured to detect a marker disposed near the lockers and to trigger the imaging scan in response to this detected marker. The marker is one of a square fiducial code, two-dimensional barcode, a specific color marker, or a specific infrared color.

The system further comprises an object supporting surface including one or more weight sensors for selecting a locker from the plurality of lockers for the object.

In another aspect, a method for automatically determining which locker of a plurality of lockers into which to place an object, the method comprising maintaining storage volume data and availability of each locker of the plurality of lockers; performing an imaging scan of objects placed near the plurality of lockers; collecting image data of one or more objects detected in the imaging scan; measuring a volume of the one or more objects based on the collected image data; and selecting one or more lockers of the plurality of lockers with enough storage area to enclose the one or more objects based on the measured volume of the one or more objects and on the storage volume and availability of each locker.

Embodiments of the system may include one or more of the following features, or any combination thereof.

The steps of performing an imaging scan of the objects placed near the plurality of lockers, collecting image data of one or more objects detected in the imaging scan, and measuring a volume of the one or more objects based on the collected image data are performed by a handheld mobile device.

The step of selecting one or more lockers of the plurality of lockers with enough storage area to enclose the one or more objects based on the measured volume of the one or more objects and on the storage volume and availability of each locker is performed by the handheld mobile device.

The method further comprises sending, by the device to a locker station, an identity of each selected locker, and opening, by the locker station, a door of each locker selected by the device.

The step of selecting one or more lockers of the plurality of lockers with enough storage area to enclose the one or more objects based on the measured volume of the one or more objects and on the storage volume and availability of each locker is performed by a locker station.

The method further comprises the step of sending, by the device to the locker station, the measured volume of the one or more objects detected in the imaging scan, and opening, by the locker station, a door of each locker selected by the locker station.

The steps of performing an imaging scan of the object(s) placed near the plurality of lockers, collecting image data of one or more objects detected in the imaging scan, and measuring a volume of the one or more objects based on the collected image data are performed by a stationary device.

The method further comprises the steps of detecting multiple objects in the imaging scan and recommending an arrangement in which to place the multiple objects within the one or more selected lockers.

The method further comprises the step of considering fragility and/or weight of each object of the multiple objects when recommending an arrangement in which to place the multiple objects within the one or more selected lockers.

The method further comprises the steps of detecting multiple objects in the imaging scan, selecting multiple lockers to place the multiple objects in, and recommending which subset of the multiple objects to place in each selected locker.

The method further comprises the step of guiding personnel to the one or more selected lockers using light, audio cues, electronic messaging or any combination thereof.

The method further comprises the steps of displaying a graphical user interface with a button and triggering the imaging scan when the button is pressed.

The method further comprises the steps of detecting motion in captured images corresponding to placement of the one or more objects near the lockers and triggering the imaging scan when the motion has ceased.

The method further comprises the steps of recognizing a feature or object near or on the supporting surface and triggering the imaging scan in response to this recognized feature or object.

The method further comprises the steps of detecting a marker disposed near the lockers and triggering the imaging scan in response to this detected marker. The marker is one of a square fiducial code, two-dimensional barcode, a specific color marker, or a specific infrared color.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 shows one embodiment of an automated locker-selection system deployed in an area.

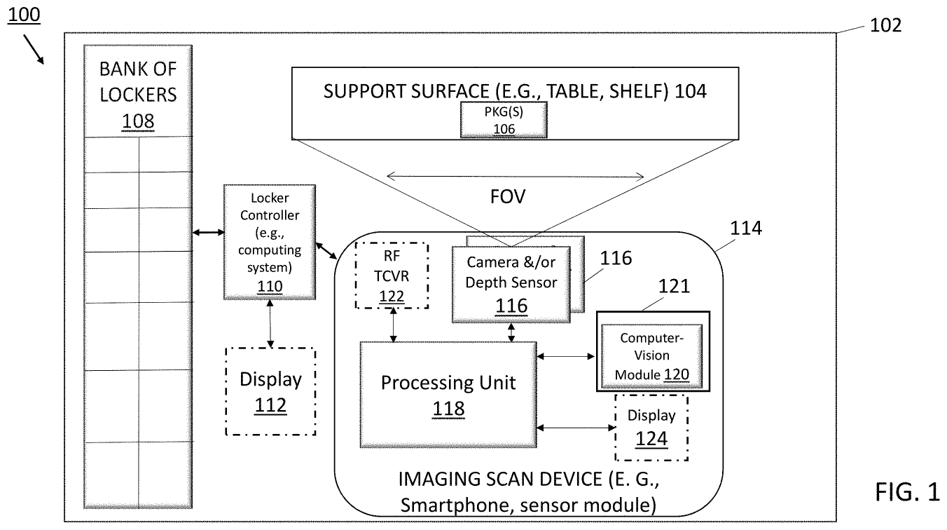

FIG. 2 shows an embodiment of a process for automatically selecting and opening a locker, in accordance with some embodiments.

### DETAILED DESCRIPTION

The area 102 can be, for example, in a store, supermarket, warehouse, business enterprise, inventory, room, closet, hallway, cupboards, lockers, the cargo bay of a delivery truck or water-going vessel, each with or without secured access. The area 102 includes an object-supporting surface 104. Examples of the object-supporting surface 104 include, but are not limited to, desktops, tables, shelves, and floor space. Also in the area 102 is a plurality of storage lockers 108 of various sizes.

In communication with the lockers 108 is a locker station 110, e.g., a computing system, kiosk, a controller located in locker array. The locker station 110 maintains a record (e.g., a database) of each locker's location in the locker array, which lockers contain objects, which lockers are empty (i.e., available), their storage capacity, volume, and/or their dimensions (i.e., depth, height, and width). Preferably, the storage area within a locker is box-like in shape, but a given locker may have compartments or nooks. In such instances, the locker station 110 also maintains data (e.g., capacity, availability) about such features in the database. The locker station 110 includes memory (not shown) to keep the data about the lockers in the database. Although the locker station 110 is shown to be in the same area 102 as the lockers 108, the locker station may be embodied by a remote server.

The locker station 110 also controls the locking and unlocking mechanism for each locker and can automatically lock and unlock each locker individually. Preferably, the door of each locker becomes noticeably ajar when the locker station 110 automatically unlocks that locker. The locker station 110 includes a processor (not shown) to submit lock and unlock commands to the lockers. Coupled to the locker station 110 is an optional display 112, which may be used to graphically display the locker array 108 and show which locker or lockers are open and ready to receive items to be stored. The locker station 110 may also include an RF transceiver (not shown) to communicate wirelessly with the lockers 110 and/or a device 114, as described later in more detail, using conventional wireless technologies such as BLUETOOTH® and WIFI®. Communication between the lockers and locker station 110 and/or the device 114 and the locker station 110 may alternatively occur through wired communications.

The system 100 includes a computer-vision-based imaging scan apparatus (hereafter, device) 114. Each device 114 includes at least one camera 116 in communication with a processing unit 118. The processing unit 118 is configured to execute a computer-vision algorithm (or computer-vision module) 120, as described later in more detail, which resides in memory 121. Each device 114 can optionally include a light source (not shown), speaker (not shown), a wireless radiofrequency (RF) transceiver 122 (shown in phantom), and a display screen 124 (shown in phantom).

The device 114 may be deployed in a stationary position (i.e., fixed, not moving) near the object-supporting surface 104 in the area 102, or it may be a mobile device. As an example of a stationary deployment, the device 114 may drop down from the ceilings in a surveillance configuration so that all corners of an enterprise site are covered. In a stationary deployment, the one or more cameras are disposed to face the object-supporting surface 104, with a field of view (FOV) that covers a portion of, or all the area occupied by the object-supporting surface 104. Each separate camera 116 has its own perspective of the area and of the objects placed on the object-supporting surface 104. Embodiments with multiple cameras 116 have overlapping fields of view directed at the object-supporting surface 104; for those embodiments with a depth sensor and an RGB camera, the field of view of the depth sensor matches at least that of the RGB camera.

Mobile embodiments of the device 114 include, but are not limited to, a smartphone, tablet computer, wearable computing device, robots, automatons, or any other portable computing device. Embodiments of the mobile device 114 can further include an inertial sensor (not shown) to provide stabilization for image capture. Being portable, a person or machine carrying the mobile device can point the device (i.e., its camera(s)) at each object, capture an image of that object, process the image to obtain the object(s) dimensions and/or overall volume, and communicate this information to the locker station 110.

Embodiments of the one or more camera(s) 116, which may also be referred to herein as image or optical sensors, include RGB, infrared, and depth cameras. Depending upon the configuration of the system 100, each camera 110 may have a narrow FOV lens or a wide FOV lens, a fixed focus or a variable motorized programmable focus, and a fixed zoom or a motorized programmable zoom.

The processing unit 118 includes at least one processor, including an image processor to process images captured by the camera(s) during motion detection and/or an imaging scan. Execution of the computer-vision module 120, by the processing unit 118, operates to perform a three-dimensional imaging scan of objects on the supporting surface 104. The imaging scan collects raw image data of the objects, for example, color (e.g., RGB) data, depth data, or a combination thereof, from images captured concurrently by the one or more cameras 116. From the image data, the processing unit 118 produces a 3-dimensional (3-D) data representation (e.g., a point cloud). The processing unit 118 processes the 3-D data representation of the object and their attributes to obtain volumetric information about the objects. As an alternative to using an imaging scan to obtain this volumetric information, manual techniques, such as barcode scanning and data entry can be performed. For example, a label on the package can be scanned and from the label information, the dimensions of the package are obtained.

In an embodiment of the device 114 in stationary deployment, execution of the computer-vision module 120 can also operate to detect changes in captured images. The change detection uses the same sensors (i.e., cameras) to gather image information about the backgrounds and collect foreground images to produce change difference information. These changes can be indicative of object placement on the supporting surface, and a lack of changes in subsequently captured images can be indicative of the cessation of motion. The detection of change and subsequent cessation of motion operates to trigger the processing unit to initiate a 3-D dimensional imaging scan. The device in stationary deployment can use this automated triggering mechanism to start an imaging scan.

In a mobile embodiment of the device 114, the computer-vision module 120 can be included in an app (i.e., application program) downloaded to the device 114. When executed, this app produces a graphical user interface button on the display 124. Pressing this UI button can operate to trigger the processing unit 118 to start a 3-D dimensional imaging scan. The user interface can then guide personnel to capture images of the object(s) on the surface from multiple various angles until enough geometrical information about the objects (enough to measure their volume) has been collected. The mobile device can thus use a manual triggering mechanism to start an imaging scan. A similar manual triggering mechanism can be implemented on the screen of a stationary device, for example, a kiosk.

A mobile device can also use an automatic triggering mechanism to initiate a scan. Example types of automatic triggering mechanisms include, but are not limited to, package-recognition-based triggers and surface-recognition-based trigger. As an example of package-recognition-based automatic trigger, the handheld mobile device actively searches for objects (e.g., packages) in the scene. Seeing a package or packages automatically triggers the mobile device to compute the volume (and alert the user that it has done so). The mobile device then waits for the user to accept the results or to continue scanning if the scan was not what the user needed. As an example of a surface-recognition-based automatic trigger, the handheld mobile device is actively looking for the area of operation using object recognition, for example, by finding a specific table or the supporting surface or certain markers (i.e., predetermined) placed on the surface. Examples of markers include, but are not limited to ArUco (i.e., square fiducial markers), QR codes (i.e., two-dimensional barcode), color markers, infrared markers. Identification of the area of operation automatically triggers the mobile device to scan everything in the scene on the surface.

The device 114 is in wired or wireless communication with the locker station 110 to pass information used to determine in which locker or combination of lockers the scanned object(s) should be placed. In one embodiment, the device 114 sends the volumetric information of the objects to the locker station 110. Because the locker station 110 knows the size of each empty locker, the locker can determine which available locker is large enough to accommodate the object(s) with the reported volume. If there are multiple objects, and a single available locker is not large enough to hold them all, the locker station 110 can identity multiple lockers to use and indicate which objects are to go into which locker. In addition, if the locker station recommends placing multiple objects into a single locker, the locker station can suggest an arrangement of those objects within the locker. The formulation of this suggestion can consider such factors as an object's fragility or weight. The locker station 110 can automatically unlock (if not presently locked) and open the selected locker(s).

In an alternative embodiment, the locker station 110 sends the available locker and size data to the device 114, and the device 114 makes the determinations as to which empty locker or lockers to use based on the volumetric information. When there are multiple objects to place in storage, the device 114 can suggest how them arrange in a single locker, taking into consideration such factors as an object's fragility or weight or identify multiple lockers when a single locker is insufficient to hold all of them or when multiple lockers simplifies ease of storing them. The device 114 tells the locker station 110 which locker(s) to open, and the locker station confirms the locker selection (not the locker selection itself, but whether the selected locker(s) are available in actuality). Upon confirming the command, the locker station 110 unlocks (if necessary) and opens the selected locker(s).

In some embodiments, the device 114 and/or the locker station 110 provide additional guidance to personnel as to which locker(s) have been opened. Examples of such guidance include but are not limited to providing light guidance (e.g., lasers, projectors, LEDs, light bulbs), audio cues, messaging, highlighting the selected lockers on visual layout of the locker array 108 on a display (e.g., 112, 124), or any combination thereof.

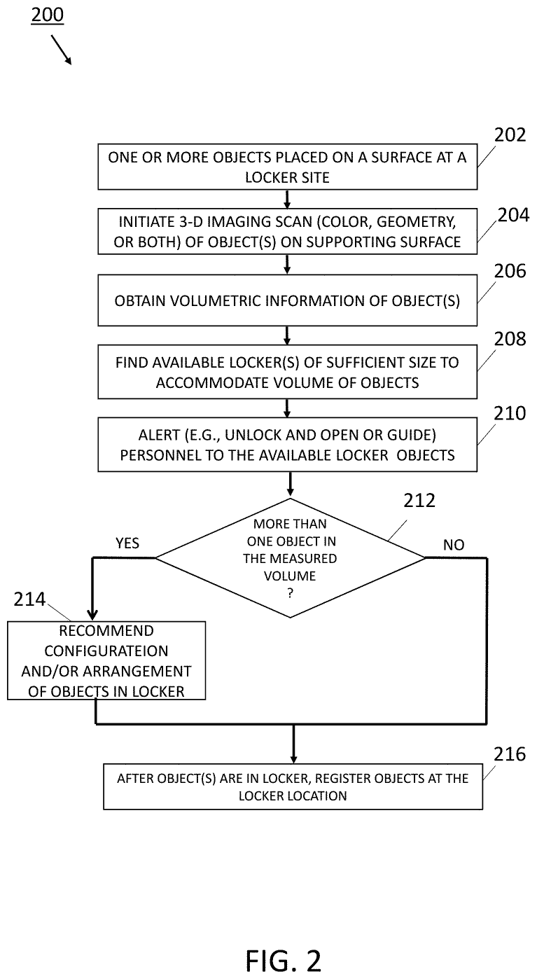

FIG. 2 shows an embodiment of a process 200 for automatically selecting and opening a locker based on the volume of object(s) delivered to the locker site and the availability of lockers with enough storage area to receive the volume. The objects may be of different sizes and shapes. At step 202, personnel deliver one or more objects to the locker site 102 and place the object(s) on the object-supporting surface 104. The device initiates (step 204) a three-dimensional imaging scan of the objects on the surface to collect raw image data of the objects on the surface. Initiation of the imaging scan can occur in response to a triggering event, for example, personnel pushes a button on the user interface displayed on the screen of a mobile or stationary device, or the device determines change has occurred on the surface and motion has ceased (i.e., objects have been placed). Based on the collected image data collected by the scan, the device obtains volumetric information of the objects. In some embodiments, the object supporting surface includes one or more detectors, for example, include weight sensors or the like, to help identify the best locker to choose for object placement (heavy items in lower lockers, etc.) or to provide sensor data received by a processor for generating instructions used for notifying users, e.g., via remote computers or other machines, to be careful with the objects when placing the objects in the lockers.

Based on the obtained volumetric information, the system identifies (step 208) one or more available lockers of large enough to accommodate the objects. Depending upon the system configuration, either the locker station 110 or the device 114 makes the identification. If multiple lockers satisfy the criterion, the system can optimize the locker selection, choosing the locker with a capacity that most closely accommodates the object volume.

When at step 212 more than one object was included in the imaging scan, the device recommends (at step 214) a locker configuration if more than one locker is needed and/or an arrangement of objects in the selected locker or lockers. Because of the measured volume, the system may determine that more than one locker is needed to accommodate the multiple objects. Accordingly, the system can recommend a subset of the objects go into one locker, a second subset of the objects go into a second different locker and so on, for as many lockers as are necessary to accommodate all the objects. At step 216, after the object(s) are placed in the locker(s), the object(s) are registered at those locker locations.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, and vertical and horizontal, and the like are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

1. A system comprising:
memory maintaining storage volume data and availability of each locker of a plurality of lockers;
one or more cameras; and
a device in communication with the one or more cameras, the device having a processing unit communicating with the one or more cameras that perform an imaging scan of the object to be placed into one of the plurality of lockers, to collect image data of one or more objects detected in the imaging scan, and to measure a volume of the one or more objects based on the collected image data; and
a processor configured to select, based on the measured volume of the one or more objects and on the storage volume and availability of each locker, one or more lockers of the plurality of lockers with enough storage volume to enclose the one or more objects.

2. The system of claim 1, wherein the one or more cameras are included in a handheld mobile device.

3. The system of claim 1, wherein the one or more cameras is/are fixed at a location where the one or more cameras has/have a field of view that covers the entire object.

4. The system of claim 1, wherein the processing unit of the device comprises the processor that is configured to select one or more lockers of the plurality of lockers with enough storage volume to enclose the one or more objects.

5. The system of claim 4, further comprising a locker station in communication with the device, the locker station sending the storage volume data and availability of each locker of the plurality of lockers to the device, the device sending to the locker station an identity of each selected locker, and the locker station opening a door of each locker selected by the device.

6. The system of claim 1, further comprising a locker station in communication with the device, the device sending to the locker station the measured volume of the one or more objects detected in the camera's or cameras' imaging scan, and the locker station comprising the processor configured to select one or more lockers of the plurality of lockers that has enough storage volume to enclose the one or more objects.

7. The system of claim 6, wherein the processor of the locker station causes a door of each selected locker to open automatically.

8. The system of claim 1, wherein the processing unit detects multiple objects in the imaging scan and is further configured to recommend an arrangement in which to place the multiple objects within the one or more selected lockers.

9. The system of claim 8, wherein the processing unit is further configured to consider fragility and/or weight of each object of the multiple objects when recommending an arrangement in which to place the multiple objects within the one or more selected lockers.

10. The system of claim 1, wherein the processing unit detects multiple objects in the imaging scan and is further configured to select multiple lockers to place the multiple objects in and to recommend which subset of the multiple objects to place in each selected locker.

11. The system of claim 1, further comprising a light source, and wherein the processing unit is further configured to use light to guide personnel to the one or more selected lockers, with a light source illuminating the selected lockers either from a remote source such as a laser or light projector or on or near the locker(s) itself such as an LED light above, on or inside each locker.

12. The system of claim 1, further comprising a speaker, and wherein the processing unit is further configured to use audio cues to guide personnel to the one or more selected lockers.

13. The system of claim 1, wherein the processing unit is configured to display a graphical user interface with a button and to trigger the imaging scan when the button is pressed.

14. The system of claim 1, wherein the processing unit is configured to detect motion in captured images corresponding to the placement of the one or more objects in or on an area near the lockers and to trigger the imaging scan when the motion has ceased.

15. The system of claim 1, wherein the processing unit is configured to recognize a feature or object near the lockers and to trigger the imaging scan in response to this recognized feature or object.

16. The system of claim 1, wherein the processing unit is configured to detect a marker disposed near the lockers and to trigger the imaging scan in response to this detected marker.

17. The system of claim 16, wherein the marker is one of a square fiducial code, two-dimensional barcode, a specific color marker, or a specific infrared color.

18. The system of claim 1, further comprising an object supporting surface including one or more weight sensors for selecting a locker from the plurality of lockers for the object.

19. A method for automatically determining which locker of a plurality of lockers into which to place an object, the method comprising:
maintaining storage volume data and availability of each locker of the plurality of lockers;
performing an imaging scan of objects placed near the plurality of lockers;
collecting image data of one or more objects detected in the imaging scan;
measuring a volume of the one or more objects based on the collected image data;
selecting one or more lockers of the plurality of lockers with enough storage area to enclose the one or more objects based on the measured volume of the one or more objects and on the storage volume and availability of each locker.

20. The method of claim 19, wherein the steps of performing an imaging scan of the objects placed near the plurality of lockers, collecting image data of one or more objects detected in the imaging scan, and measuring a volume of the one or more objects based on the collected image data are performed by a handheld mobile device.

21.-34. (canceled)
